(19) United States
(12) Patent Application Publication
(10) Pub. No.: US 2007/0043675 A1
(43) Pub. Date: Feb. 22, 2007

(54) SOFTWARE LICENSE MANAGER

(75) Inventors: Johannes Birzer, Hochstadt (DE); Mirko Danz, Feucht (DE); Andreas Hartinger, Norman, OK (US); Martin Kiesel, Poxdorf (DE)

Correspondence Address: Henry M. Feiereisen;Henry M. Feiereisen, LLC, Suite 4714, 350 Fifth Avenue, New York, NY, 10118, US

(73) Assignee: Siemens Aktiengesellschaft, Munchen (DE)

(21) Appl. No.: 11/466,980

(22) Filed: Aug. 24, 2006

Related U.S. Application Data
(63) Continuation-in-part of application No. 10/276,604, filed on Dec. 18, 2002.
(63) Continuation-in-part of application No. 10/276,605, filed on Dec. 18, 2002.
(63) Continuation-in-part of application No. 10/292,889, filed on Nov. 12, 2002.

(30) Foreign Application Priority Data
May 15, 2000 (DE) 100 23 818.1
May 15, 2000 (DE) 100 23 827.0
Nov. 14, 2001 (DE) 101 55 752.3

(51) Int. Cl. G06Q 99/00; H04L 9/00; H04K 1/00

(52) U.S. Cl. 705/51

(57) ABSTRACT

A method is disclosed for licensing software components and providing access authorization to software components and/or instantiations of software objects through sublicenses and/or value points, wherein a sublicense and/or value points are associated with each software module and/or the instantiation of a module. Access authorization is based on a comparison between acquired sublicenses/value points and the sublicenses/value points required for an machine task. Sublicenses/value points can be exchanged/traded between different machines and/or users.

### CROSS-REFERENCES TO RELATED APPLICATIONS

This application is a Continuation-in-Part of U.S. patent application Ser. No. 10/276,604, filed Dec. 18, 2002, which is the National Stage of International Application No. PCT/DE01/01634, filed Apr. 30, 2001, which in turn claims the priority of German Patent Application, Serial No. 100 23 818.1, filed May 15, 2000, pursuant to 35 U.S.C. 119(a)-(d), and a Continuation-In-Part of U.S. patent application Ser. No. 10/276,605, filed Dec. 18, 2002, which is the National Stage of International Application No. PCT/DE01/01689, filed May 3, 2001, which in turn claims the priority of German Patent Application, Serial No. 100 23 827.0, filed May 15, 2000, pursuant to 35 U.S.C. 119(a)-(d), and a Continuation-In-Part of U.S. patent application Ser. No. 10/292,889, filed Nov. 12, 2002; which claims the priority of German Patent Application, Serial No. 101 55 752.3, filed Nov. 14, 2001, pursuant to 35 U.S.C. 119(a)-(d), the contents of which are incorporated herein in their entirety by reference.

### BACKGROUND OF THE INVENTION

The present invention relates to a method for licensing and/or access authorization of software modules for industrial controllers and/or computer systems.

It is customary to explicitly associate licensing and access authorization of software modules with these software components. For example, if a user uses the software module A three times, the software module B twice, and the software module C once, then he obtains from the software supplier a special authorization for the desired and requested supplied software in form of licenses that are matched to the order. This has the disadvantage that the license agreement has to be changed when the licenses are exchanged, and that the released licenses also need to be changed if the software is protected.

In addition to purchasing a license for using a software components, it is also possible to obtain a license for using software components by a leasing agreement (VDI News of Jan. 7, 2000). Leasing financing has the advantage that the liquidity of the Company is protected as compared to a direct purchase. The leasing rates are also balance-neutral. Disadvantageously, however, the leasing contract has to be changed if the demand for software components changes.

It would therefore be desirable to provide a user of software modules with a simple, flexible method for licensing and/or access authorization of software modules, that can be adapted to changing requirements and employed particularly in distributed systems.

### SUMMARY OF THE INVENTION

According to one aspect of the invention, with a method for authorizing usage of a software program for programming an industrial controller, a total value is associated with the software program, and the software program can be divided into separate software modules corresponding to different physical and operational machine tasks. Each software module has its own value and value points associated with the value.

The term software module will be used hereinafter synonymously with the term software program or software component. This includes, for example, software for office applications, software for controllers and/or software for computer systems. The term control will be used synonymously with automatic control, open-loop control and the like.

The method includes defining a machine task to be performed by a machine controlled by the industrial controller, providing a user of the machine with a predetermined number of value points, providing access authorization to at least one of the software modules required for performing the machine task if the number of provided value points is at least equal to a number of value points required for usage of the at least one software module; and monitoring an actual balance between the number of provided value points and a number of required value points consumed when using the at least one software module.

A license manager may be employed to compute and monitor the actual balance between the acquired and used value points.

The invention has the advantage that a customer does not sign a license agreement covering the used software modules and their quantity, but rather obtains a license agreement for the required modules through value points. The customer can flexibly and usage-specific use the required software modules within the obtained “value point license”. A valuation in the form of value points instead of a price is associated with the software modules, wherein each value point has a price. Changes at the customer regarding the requirements or new software components do not require a change in the license agreement, if the valuation of the actually required software modules is covered by the already obtained value points. The use of value points as license currency for using software modules thereby significantly facilitates the management and license administration of software not only for the system, but also for an entire company. In particular, the invention simplifies the licensing process for software modules which are frequently changed or exchanged. Moreover, licensing according to the invention affords a high granularity and easy combination of the software modules. The invention also permits pre-ordering without specifying the functionality, i.e., a purchaser is not tied to specific software modules, but can obtain a number of value points and use the supply of points for any of the software modules.

By using value points as authorization currency for using software modules, the customer or user can make changes to his software requirements without changing the license agreement. This eliminates additional management and administration processes. The customer can, for example, obtain a credit voucher for a number of value points and can flexibly hand over or exchange these value points for software modules. This allows the customer to individually assemble a software order without being obligated to accept preassembled packages from the supplier.

According to another advantageous embodiment of the invention, the customer can be authorized to use the actually desired software modules, when the number of the value points already acquired by the customer reaches at least the sum total of value points of the actually desired software modules. When using the software modules, there is no longer a verification required if an explicit license of the desired software module is present. Instead, the customer will be authorized to use the software by simply checking the total amount of the value points. By associating specific value points with each software module, the sum of the value points of the actually desired software modules can be easily compared with the value points obtained through the licensing agreement. The customer is authorized to use the software as long as the sum of the value points for the actually desired software modules does not exceed the value point account of the customer.

By having a license manager permanently monitor the actual number of required value points and comparing that number with the available value points, a customer account can be managed according to demand and usage. The license manager can easily integrate and consider the license implications of newly acquired value points, but can also easily recognize if additional value points are required in an application. The license manager determines permanently the “value point debit”, i.e., the sum of the value points of all actually required software modules, and compares that number with the “value point credit”, i.e., the total credit balance of value points acquired with the license.

According to a first advantageous embodiment of the invention, the license manager can be implemented as a mobile agent, which allows the licensing method to be easily employed in distributed environments. The software modules subject to a license can then be executed on devices that are connected, for example, by Fieldbus links, as well as by local area networks (LAN) or Internet and intranet links.

According to another advantageous embodiment of the invention, the value points required by the system for an application can be computed automatically. A user can thereby immediately recognize the licensing costs (in the form of value points) associated with a selected configuration of software modules or applications. The required number of value points can be determined by the license manager or, for example in industrial controllers, by a routine in the engineering system.

According to another advantageous embodiment of the invention, the value points can be transmitted via a fixed data link, such as a wired connection or a data bus, or a network, such as an intranet, a LAN or WAN, or the Internet to the industrial controller/control system or to the computer systems. Accordingly, an additional physical data carrier, such as a CD-ROM or flash drive, or an additional hardware component is not required for transmitting the license currency (value points) to the customer.

According to yet another advantageous embodiment of the invention, the value points can be supplied on a data carrier, such as a hard drive or another computer-readable storage medium, which is typically already implemented for operating the controller or computer system. This facilitates handling at the controller and/or computer system and can also save both storage space and storage costs.

According to yet another advantageous embodiment of the invention, the value points can be supplied to the controller or computer system on a memory card. A memory card which can be inserted easily in a provided slot is typically routinely used with control devices.

According to another advantageous embodiment of the invention, the value points can be supplied to the control or computer system on a Multi-Media-Card (MMC) memory card which are suitable as information carriers due to their form and size. MMC memory cards have a similar look as the small SIM card used in cell phones.

Another advantageous embodiment of the invention provides that the value points for the entire system and/or an entire installation can be supplied at a single point and/or a single device or at different points and/or at different devices. This allows a customer to import license information (license currency of the form of value points) for software components relating to the entire system or installation in the same manner as for a single point, for example a single device. This makes it easier for a customer to handle licenses, in particular in distributed applications and network operations.

According to another advantageous embodiment of the invention, the required number and the actually available number of value points for the access authorization are compared when the software modules are installed. In other words, it is checked only at the time a customer of the software modules actually installs the acquired software modules on a device or a system, if the number of obtained value points is sufficient for the desired software modules. By debiting a value point account to the customer only when the software module is installed on a device or a system, the authorization of the customer for use of the software modules is checked only when the customer actually intends to use the modules. The value points are therefore entered into the accounting system only when actually required.

According to another advantageous embodiment of the invention, the required number and the actually available number of value points for the access authorization are compared only when the software modules are actually used. The value points can hence be associated with the number of manifestations and/or instantiations of the software modules. In this way, a customer can be provided with application-specific licensing methods for his explicit requirements. A customer who acquires a software module, for example a technology packet “positioning”, for motion control in an industrial controller, does not pay for the software with value points when he installs the technology packet, but rather only pays when a technology object of this technology packet “positioning” is actually used. The technology packet “positioning” can also include the technology object “positioning axis.” A customer is billed for the required number of manifestations and/or instances of the technology object “positioning axis” or additional technology objects, i.e., his value point account is debited for the number of the manifestations and/or instances of the technology objects. By authorizing specific instances at run-time, the value point account of a customer is only debited for those software modules which are actually needed and used for the applications. This provides a finely granulated accounting mechanism, so that a customer has to pay only for the required and actually used functionality.

Another advantageous embodiment of the invention provides that the data carrier for the value points can also be implemented as a key containing information. This allows a bundling of hardware, licensing information in the form of value points and additional information (e.g. regarding licensors).

Licenses can be stored on memory cards and/or MMC memory cards by providing these computer-readable data carriers with an unalterable hardware identification and with additional license information in form of an identification number that is generated by a encryption algorithm and uniquely associates the hardware identification with the license information, which are then supplied to a computer system or the control device that execute the software components in form of the computer-readable data carrier.

Advantageously, the unique hardware identification (ID) which is placed on the data carrier by the manufacturer during the manufacturing process of the computer-readable data carrier, is written in a region of the data carrier which is subsequently only readable, but not writable. The hardware ID is only given out once and is therefore unique. Since a region containing the hardware ID can only be read out, but not written to, the hardware ID (for example the serial number) cannot be copied to another data carrier of this type, which makes cloning of data carriers impossible. In addition to the hardware ID, the computer-readable data carrier includes additional useful data regions which may be writable.

The usable data regions of the computer readable data carrier can include, for example, information which can be used for operating a computer system or a control device. To operate controllers, the usable data regions of the computer-readable data carrier can include, for example, the complete run-time software and/or parameterization and/or configuration information, as well as applications.

According to another advantageous embodiment, value points may be provided to and installed on different machines or different machine controllers, and may be traded between different machines, controllers and/or users of a machine. This is particularly advantageous in networked installations, where different machining operations are performed by different machines at different times, thus temporarily freeing up software components on one machine, with the number of value points available for use for another, possibly different task on other machine(s).

According to another aspect of the invention, in a method for authorizing usage of a software program for programming a machine controller, each software module has its own associated sublicense instead of respective value points. The method includes defining a machine task to be performed by a machine tool of a machine controlled by the machine controller, providing a user of a machine with a predetermined number of sublicenses to perform the machine task, said software modules covered by the sublicenses being stored in the machine controller, monitoring a total number of sublicenses for the software modules available to the user and for the software modules being stored in the machine controller, detecting a change in the sublicenses for the software modules required to enable reconfiguring a machine task, and determining a sublicense for the software module is available from another machine controller to perform the reconfigured machine task, if a sublicense is not available on the machine controller.

This approach is also advantageous in networked installations, where different machining operations are performed by different machines at different times, thus temporarily freeing up software components on one machine, with the number of sublicenses then available for use for another, possibly different task on other machine(s).

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of software modules for motion control;

FIG. 2 shows schematically a technology packet with technology objects for positioning;

FIG. 3 is a scenario for licensing and access authorization of software modules on a device by using value points;

FIG. 4 is a scenario for licensing and access authorization of software modules for several networked devices by using value points;

FIG. 5 shows the internal organization of a Multi-Media-Card (MMC) memory card; and

FIG. 6 shows schematically a diagram of the connection between control devices and a server via an Ethernet or Internet link.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

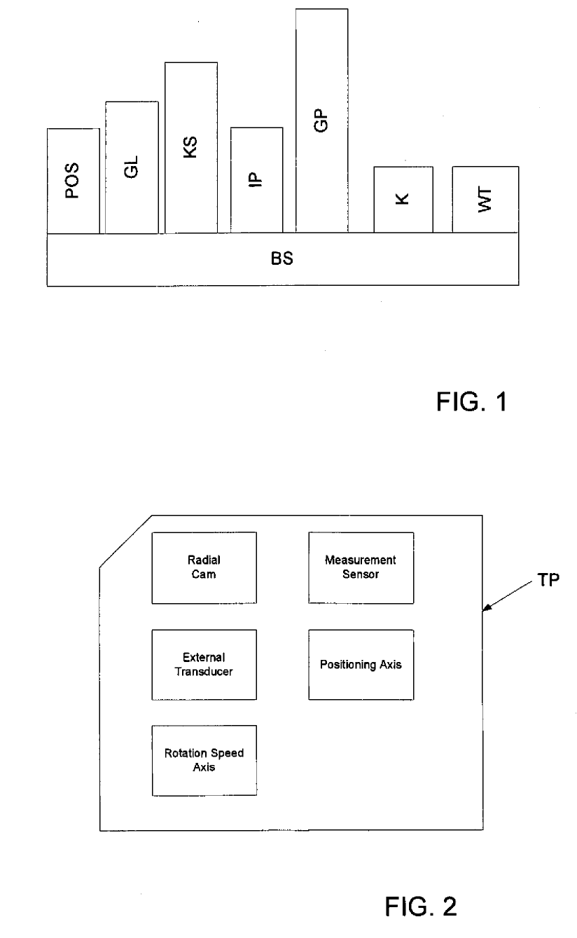

Turning now to the drawing, and in particular to FIG. 1, there is shown a schematic diagram of software modules for a motion controller. A motion controller typically includes a basic system BS and software modules POS (Positioning), GL (Synchronization), KS (Radial Cam), IP (Interpolation), which a user can acquire to fit specific requirements and applications. The software modules represent technology packets for certain functionalities and can include additional technology objects. The software modules of the motion controller are indicated schematically in FIG. 1 by rectangles. In addition to the basic system BS, a user or purchaser can acquire software modules (POS) for positioning, (GL) for synchronization, (KS) for radial cam disks, and/or (IP) for interpolation. The user can also purchase a total package that includes Positioning, Synchronization, Radial Cams, and Interpolation in a single software module GP. In addition to the typical functionalities for motion control devices, a user or customer can also acquire software modules K (Plastic) or WT (Additional Technologies) for specific technologies. As indicated in FIG. 1, the software component K (plastic) can be acquired for motion control devices that are intended to be used specifically for machining plastic. As also indicated in FIG. 1, specific software components WT can be required for additional technologies. A valuation in the form of value points is associated with all the illustrated software modules. A user can flexibly use the desired software modules by staying within the number of the acquired value points (licensing). Accordingly, a user can scale the motion control device simply by using certain software modules and thereby customize the control tasks.

FIG. 2 shows schematically (beveled rectangle) an exemplary technology packet (TP) “Positioning”. The technology packet may include the following exemplary technology objects which are indicated as rectangles: Radial Cam, External Transducer, Rotation Speed Axis, Measurement Sensor and Positioning Axis. A user can use several manifestations or instances of these technology objects in a single application.

User authorization (i.e., a check if sufficient value points (WP) or sublicenses are available at the customer/user for the desired software module) can then be checked during installation, i.e., when the technology packets are loaded. Alternatively, the user authorization can be checked during use, i.e., when the technology objects are instantiated. For example, if 3 WP are associated with the technology object Rotation Speed Axis, then a user who wishes to use two instances of the technology object Rotation Speed Axis has to acquire 6 WP. This possibility of linking the licensing process to the actual use of the technology objects is flexible and transparent to the customer.

Although the exemplary embodiment of the invention will be described below more specifically by using value points, the invention is not limited to the use of value points, and defined sublicenses for each machining operation or task can be employed. The use of sublicenses is somewhat more limited since, for example, a software module with a higher associated number of value points can in this case not be traded for a greater number of software modules that each have a smaller associated number of value points. However, the process is almost identical in all other aspects. It is important with the present invention that value points and/or sublicenses are part of an overall package of licensed software and can be freely assigned and/or traded during installation or when actually used in a machining task.

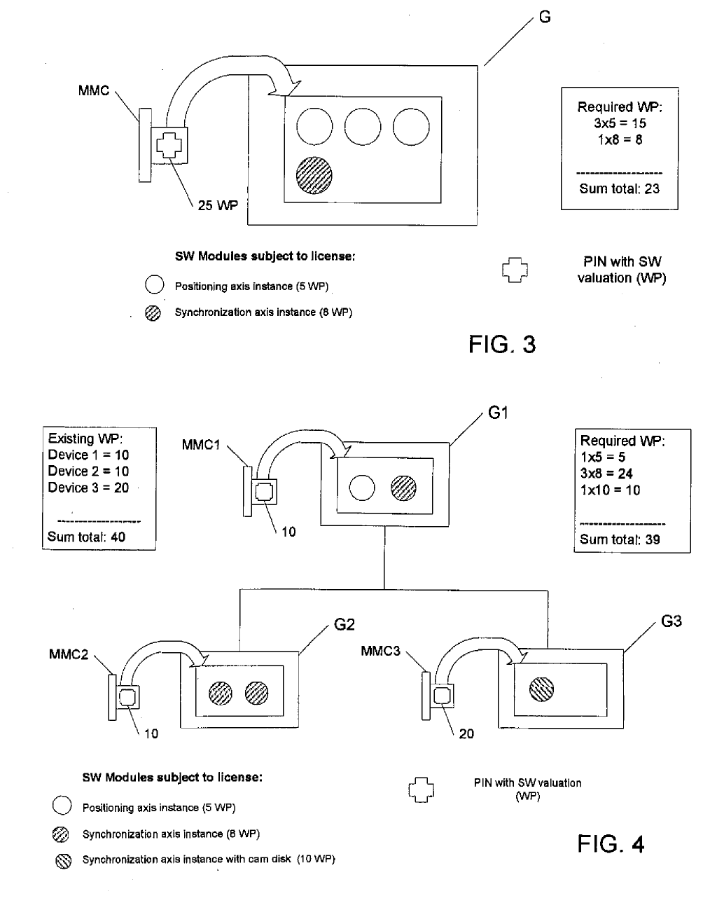

FIG. 3 depicts a scenario for licensing and access authorization of software modules on a single device using value points. Software modules subject to licenses or sublicenses, such as instances of technology objects (indicated as small circles), are to run on the device G (e.g., a motion controller). The device G is shown as a rectangle. An identification number PIN, which designates the software licenses, is assigned to the device on an integratable MMC-memory card MMC (indicated by open arrows) which includes the software valuation in the form of 25 value points (WP). The identification number PIN, which includes the software valuation in the form of value points, is indicated by a small cross. Instances to be executed on the device G are indicated by differently patterned small circles.

The software modules in FIG. 3 are interpreted as instantiations or instances of objects. A positioning axis instance is depicted by the open circle. A positioning instance is valued at five value points. The circle hatched from the lower left to the upper right depicts a synchronization axis instance. The synchronization axis instance is valued at eight value points. 3 positioning axis instances (each requiring 5 WP) and one synchronization instance (requires 8 WP) are to be executed on the device G.

25 value points (WP) exist on the device G which are introduced by the MMC memory card. Based on the actual configuration, however, only 23 value points are required. The field inside the box on the upper right side of FIG. 1 shows the required value points. The three positioning axis instances require 3×5 WP and the synchronization axis instance 8 WP, for a total of 23 WP. The user is therefore permitted to run the desired configuration (3 positioning axis instances and one synchronization axis instance) on the device G.

A license manager implemented in software continuously checks the nominal vs. actual balance of required and existing value points WP and/or sublicenses. The license manager can be integrated, for example, in the basic system BS of the controller (see FIG. 1).

FIG. 4 shows a scenario for licensing and access authorization of software modules for several networked devices using value points.

The illustrated system includes three networked devices G1, G2 and G3 shown as rectangles, with the network indicated by connecting lines. An identification number PIN containing the software valuation in the form of value points is assigned to each device G1-G3 on an integratable MMC memory card MMC1-MMC3 (indicated by open arrows). In the scenario depicted in FIG. 4, MMC1 includes ten, MMC2 also ten, and MMC3 twenty value points, associated with the corresponding devices G1-G3. Accordingly, the entire system contains forty value points.

In the field in the upper left corner of FIG. 4, the value points existing in the system are represented for each device as well as their sum total. The identification number PIN containing the software valuation in the form of value points is indicated by a small cross. The software modules to be executed on the devices G1-G3 are depicted by differently patterned small circles. The software modules in FIG. 4 are interpreted as instantiations or instances of object types. A positioning axis instance is illustrated by an open circle. The valuation of a positioning axis instance is five value points. A circle with a hatching from lower left to the upper right depicts a synchronization axis instance. The valuation of the synchronization axis instance is eight value points. The circle with a hatching from upper left to the lower right depicts a synchronization axis instance with a cam disk. The valuation of this software module is ten value points.

Each of the acquired value points (software valuation) is encrypted with an identification number PIN. The identification numbers PIN are entered into the system or the devices G1-G3 from the MMC memory cards MMC1-MMC3, where they are stored.

In the example of FIG. 4, the MMC1 memory card has ten value points, the MMC2 memory card has also ten value points, and to the MMC3 memory card has twenty value points. In the upper left field of the Figure, the value points existing in the system and/or the devices are illustrated, with a total of forty value points existing in the system. The existing value points WP can be viewed as credit, or as value point credit. In the illustrated example, a total of forty value points is available which are distributed over the three MMC memory cards MMC1-MMC3.

However, only 39 value points are required based on the actual configuration, because the device G1 requires one positioning axis instance, i.e., 5 WP, and one synchronization axis instance, i.e., 8 WP; the device G2 requires two positioning axis instances, i.e. 2×8 WP; and the device G3 one synchronization axis instance with radial cam disk, i.e. 10 WP. The field in the upper right in the Figure shows the number of value points required in the system, namely 39. The required value points represent the usage or the value point debit. Since a sufficient number of value points (forty) is available in the system, the configuration can be operated in this form and is fully licensed. The total number of value points in the system decides the access authorization.

The license manager permanently tracks the number of value points WP required by an application and compares that number with the number of value points WP existing for the entire system. If a deficiency of value points WP is detected, operation in the actual configuration is not permitted and/or enabled.

With respect to local devices, the number of the required value points WP can exceed the number of the existing value points WP. In the example depicted in FIG. 4, a synchronization axis instance and a positioning axis instance run on the device G2 requiring 16 value points. However, only 10 value points are stored on the local MMC memory card MMC1 for the device G2. This local value point deficit is compensated by the value points assigned to the remaining devices. Accordingly, even when no value points are assigned to individual devices, the software components assigned to the devices can still run properly and are properly licensed, if the sum total of the value points existing in the system is sufficient. Alternatively, all value points required for the system can be introduced on a single device.

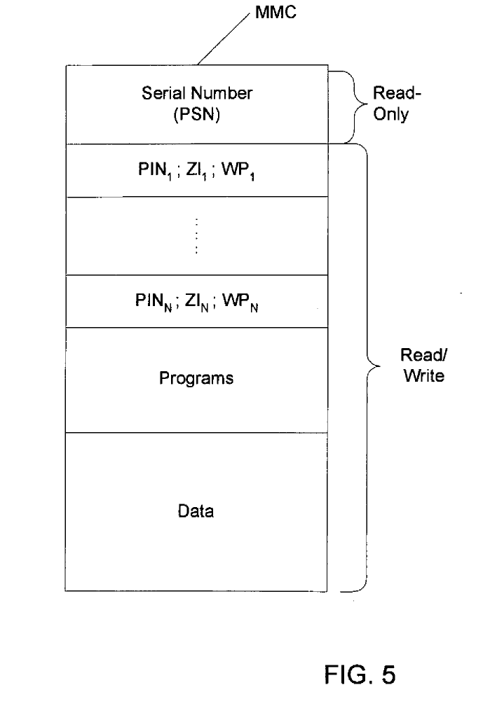

FIG. 5 shows schematically the internal organization of an MMC memory card. The MMC memory card is organized into blocks, with the uppermost block of the card representing a Card Identification Block which is written by the manufacturer of the MMC memory card. The Card Identification Block includes a unique hardware identification PSN. This region can only be read (by the checking software), but cannot be copied. The subsequent blocks include the licenses value points WP1-WPn, additional information ZI1-ZIn (e.g., information in the event of different licensors), as well as identification numbers PIN1-PINn generated by an encryption algorithm (for different licensors). An MMC memory card can also contain programs and data.

All blocks of an MMC memory card, except for the block containing the unique hardware identification PSN and which is only readable, are both readable and writeable and can also be copied

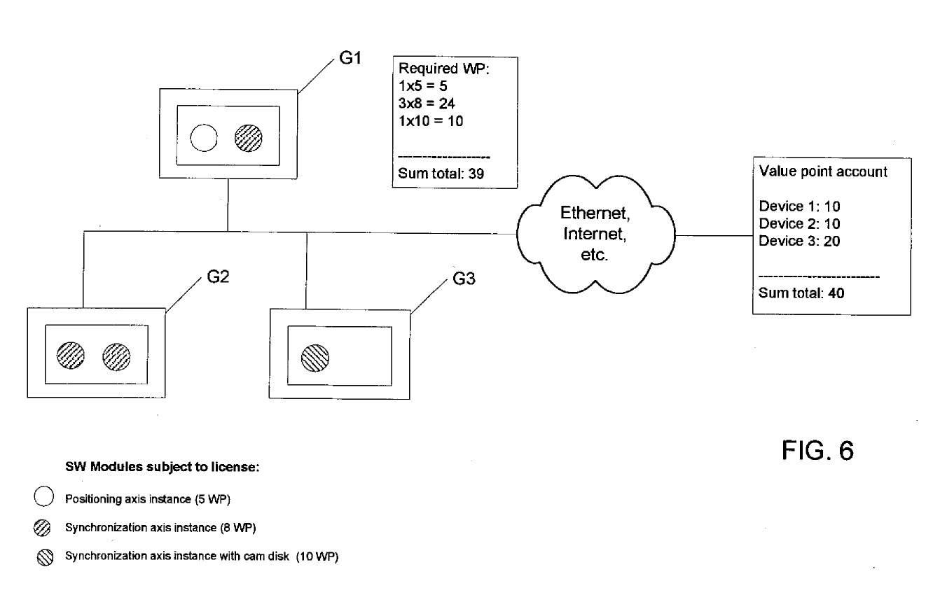

FIG. 6 illustrates a controller comprised of three networked devices G1, G2, and G3, with the device is indicated by rectangles and the network indicated by connecting lines. The controller can be connected with a server S, for example, via an Ethernet or in Internet connection. Value points can be transmitted to the controller and the devices G1-G3 via the Ethernet and/or Internet connection. The server S is indicated on the right-hand side of FIG. 6 by a rectangle.

The software modules (in FIG. 6 as exemplary instances of technology objects) to be executed on the devices G1-G3 are indicated by differently patterned small circles. The open circle indicates a positioning axis instance. The valuation of a positioning axis instance is five value points (5 WP). A synchronization axis instance is depicted by a circle with hatching from lower left to the upper right. The valuation of this synchronization axis instance is eight value points (8 WP). A synchronization axis instance with radial cam disk is indicated by a circle with hatching from the upper left to the lower right, having a valuation of ten value points (10 WP).

The server S transfers via the Ethernet or Internet connection forty WP to the devices G1-G3 of the controller. The value point account of the server S includes, for example, for the device G1 ten WP, for the device G2 also ten WP, and for the device G3 2 twenty WP. Accordingly, there are altogether 40 WP available to the controller.

However, based on the actual configuration, only thirty-nine value points are required, because the device G1 requires one positioning axis instance, i.e. 5 WP, and one synchronization axis instance, i.e. 8 WP; the device G2 requires two synchronization axis instances, i.e. 2×8 WP; and the device G3 requires one synchronization axis instance with radial cam disk, i.e. 10 WP. The boxed-in field in the center shows the number of value points required for the system, namely 39. The required licenses represent the usage or the value point debit. Since a sufficient number of licenses (forty) is available in the entire system, the operation in this configuration, which requires 39 value points, is permitted and properly licensed. Access authorization is decided based on the sum total of the value points in the system.

With respect to local devices, the number of the required value points can exceed the number of the existing value points. In the example depicted in FIG. 6, two synchronization axis instances run on the device G2 requiring 16 value points. However, only 10 value points are stored on the server S account for the device G2. This local value point deficit is compensated by the value points associated with the other devices. Accordingly, although no value points may be assigned to some individual devices, the software components assigned to these devices can still run properly under a license, if the sum total of the value points existing in the system is sufficient. Alternatively, all value points WP required for operating the controller can be associated with a single device of the controller.

In the scenario depicted in FIG. 6, a license manager implemented in software continuously checks the nominal vs. actual balance of the required and existing value points and/or sublicenses. In a distributed operation (distributed, for example, over a local area network or the Internet), the license manager can be implemented as a mobile agent.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for authorizing usage of a software program for programming an industrial controller, said software program being dividable into separate software modules corresponding to different physical and operational machine tasks, each software module having its own value and value points associated with the value, the method comprising:
defining a machining operation to be performed by a machine controlled by the industrial controller;
subdividing the machining operation into at least one of the machine tasks;
providing a user of the machine with a predetermined number of value points;
providing access authorization to at least one of the software modules required for performing the at least one machine task if the number of provided value points is at least equal to a number of value points required for usage of the at least one software module; and
monitoring an actual balance between the number of provided value points and a number of required value points consumed when using the at least one software module.

2. The method of claim 1, wherein the actual balance is monitored by a license manager.

3. The method of claim 1, wherein the actual balance is monitored by a mobile agent.

4. The method of claim 1, wherein the number of value points to be used as usage authorization for an application is automatically computed.

5. The method of claim 1, wherein the value points are provided via a data line or via the Internet.

6. The method of claim 1, wherein the value points are provided on a data carrier.

7. The method of claim 1, wherein the data carrier comprises a memory card, a multimedia card or an MMC memory card.

8. The method of claim 1, wherein the value points are provided at a single physical installation location of the machine controller.

9. The method of claim 1, wherein the value points are provided at different physical installation locations of the machine controller.

10. The method of claim 1, wherein providing the access authorization includes comparing the number of value points required for the access authorization when the at least one software module is installed.

11. The method of claim 1, wherein providing the access authorization includes comparing the number of value points required for the access authorization when the at least one software module is used.

12. The method of claim 6, wherein the data carrier for the value points comprises a key with access authorization information.

13. The method of claim 1, wherein value points can be traded between different machine controllers or different users of a machine or different machines, or a combination thereof.

14. The method of claim 1, wherein the software modules are associated with a machine controller located at a single physical location, and wherein the value points are provided for usage at the single physical location.

15. The method of claim 1, wherein the software modules are associated with at least two machine controllers located at different physical locations, and wherein the value points are provided for usage at the different physical locations.

16. A method for authorizing usage of a software program for programming a machine controller, said software program being subject to a license and being dividable into separate software modules corresponding to different physical and operational machine tasks, each software module having its own sublicense associated therewith, the method comprising:
defining a machine task to be performed by a machine tool of a machine controlled by the machine controller;
providing the machine with a predetermined number of sublicenses to perform the machine task, said software modules covered by the sublicenses being stored in the machine controller;
monitoring a total number of sublicenses for the software modules being stored in the machine controller;
detecting a change in the sublicenses for the software modules required to enable reconfiguring a machine task; and
determining by directly querying other machine controllers having stored sublicenses, if a sublicense for the software module is available from another machine controller to perform the reconfigured machine task, should a sublicense not be available on the machine controller requested to perform the reconfigured machine task.

17. The method of claim 16, wherein at least one sublicense is transmitted to a machine controller via a data line or via a network connection.

18. The method of claim 16, wherein at least one sublicense is stored on a memory card and supplied from the memory card to the machine controller.

19. The method of claim 18, wherein the memory card comprises a multimedia card (MMC memory card, MMC1-MMC3).

20. The method of claim 16, wherein for establishing access authorization, the sublicenses required to enable a machine tool to perform a machine task and the obtained sublicenses are compared at a time, when the software modules are installed in the machine controller.

21. The method of claim 16, wherein for establishing access authorization, the sublicenses required to enable a machine tool to perform a machine task and the obtained sublicenses are compared at a time, when the software modules are used in the machine controller.

22. The method of claim 16, wherein a sublicense for a software module applies to a single instantiation of the software module, and wherein a sublicense is required for every instantiation of the same software module.

23. The method of claim 16, wherein the machine task is selected from the group consisting of Positioning, Synchronization, Radial Cams, and Interpolation.

24. A computer program for usage authorization of a software program for programming an industrial controller, said software program being dividable into separate software modules corresponding to different physical and operational machine tasks, each software module having its own value and value points associated with the value, the computer program residing on a computer readable medium and comprising instructions for causing a computer to:
define a machining operation to be performed by a machine controlled by the industrial controller;
subdivide the machining operation into at least one of the machine tasks;
provide a user of the machine with a predetermined number of value points;
provide access authorization to at least one of the software modules required for performing the at least one machine task if the number of provided value points is at least equal to a number of value points required for usage of the at least one software module; and
monitor an actual balance between the number of provided value points and a number of required value points consumed when using the at least one software module.

25. The computer program of claim 24, further including instructions for causing the computer to automatically compute the number of value points to be used as usage authorization for a machine task.

26. The computer program of claim 24, further including instructions for causing the computer to receive the value points from a value point source selected from the group consisting of a data line, a network, a data carrier, a memory card, a multimedia card and an MMC memory card.

27. The computer program of claim 24, wherein the value points are provided for usage with different machines or machines located at different physical locations, with the machines capable of running the at least one required software module.
